(19) United States
(12) Patent Application Publication
(10) Pub. No.: US 2015/0188731 A1
(43) Pub. Date: Jul. 2, 2015

(54) Programmable Distributed Networking

(71) Applicant: Daniel P. Daly, Ann Arbor, MI (US)

(72) Inventor: Daniel P. Daly, Ann Arbor, MI (US)

(21) Appl. No.: 14/142,294

(22) Filed: Dec. 27, 2013

(51) Int. Cl. H04L 12/54; H04L 12/26

(52) U.S. Cl. CPC H04L 12/5689; H04L 43/00

(57) ABSTRACT

One embodiment provides a computing device. The computing device includes a processor; a network interface comprising at least one port and a network interface identifier; and a distributed module configured to identify each directly connected other computing device, receive and store a forwarding policy from a centralized controller module, and forward a received packet based, at least in part, on the forwarding policy.

### FIELD

The present disclosure relates to distributed networking, and, more particularly, to programmable distributed networking.

### BACKGROUND

Conventional network nodes, e.g., switches and/or routers, in distributed routing systems are designed to be resilient to network changes but are typically not easily reprogrammable once deployed. For example, programming exceptions in their forwarding behavior that don't fit within their pre-specified state machines may be difficult. Software-defined networking (SDN) is configured to alleviate this limitation by exposing a data path of a network node to a centralized controller and thereby providing programmability. However, an SDN-compliant network node may lose the ability to make local decisions (at the node) in response to network changes, requiring the centralized software stack to be involved in every modification of the forwarding behavior thus adding latency. Further, conventional SDN relies on an out-of-band network to connect a control plane to each network node for programming.

### BRIEF DESCRIPTION OF DRAWINGS

Features and advantages of the claimed subject matter will be apparent from the following detailed description of embodiments consistent therewith, which description should be considered with reference to the accompanying drawings, wherein:

FIG. 1 illustrates a functional block diagram of a network system consistent with various embodiments of the present disclosure;

FIG. 2A illustrates a functional block diagram of one example computing device consistent with various embodiments of the present disclosure;

FIG. 2B illustrates a functional block diagram of another example computing device consistent with various embodiments of the present disclosure;

FIG. 3 is a flowchart of distributed networking operations according to various embodiments of the present disclosure;

FIG. 4 is a flowchart of programmable networking operations according to various embodiments of the present disclosure; and

FIG. 5 is a functional block diagram of an example Clos network according to one embodiment of the present disclosure.

Although the following Detailed Description will proceed with reference being made to illustrative embodiments, many alternatives, modifications, and variations thereof will be apparent to those skilled in the art.

### DETAILED DESCRIPTION

Generally, this disclosure relates to distributed networking methods (and systems) configured to implement programmable distributed networking. The methods and systems are configured to retain local intelligence in network nodes (i.e., computing devices) while implementing programmability of, e.g., forwarding policies, by a centralized controller. The local intelligence is configured to discover a network topology and to respond relatively quickly to changes in the network topology and/or network conditions. The centralized controller is configured to provide programmable centralized decision-making and relatively flexible exception programming. A centralized controller consistent with the present disclosure is configured to provide an address and forwarding policies to reach the address to each network node while allowing the network node to adjust packet forwarding based, at least in part, on changes in local conditions, e.g., network topology, network congestion and/or load. Thus, resilience associated with distributed networking may be preserved while also providing centralized programmability. Workloads associated with network functionality may then be shared between distributed computing devices and the centralized controller.

Methods and systems consistent with the present disclosure are configured to provide programmability while including benefits associated with distributed forwarding techniques. For example, conventional debugging tools may be utilized with distributed network nodes consistent with the present disclosure thereby facilitating debugging. Methods and systems consistent with the present disclosure may support a heterogeneous deployment where a subset of switches in, e.g., a router, are configured to use conventional distributed routing techniques, e.g., IP (Internet Protocol) routing, and a remainder of the switches the router are configured to use routing techniques consistent with the present disclosure. Such a heterogeneous approach supports interoperability and may aid in the migration from a conventional distributed routing-based deployment to a conventional SDN-enabled deployment.

In an embodiment, Ethernet MAC (Media Access Control) addresses and IP concepts may be utilized to facilitate interoperability and/or use of existing network tools (e.g., for debugging). MAC addresses may be utilized as globally unique identifiers for low-level management (i.e., control) traffic and IP addresses may be used as assignable, maskable addresses for unicast and/or multicast data traffic forwarding, as described herein. Of course, other protocols that provide identification and addressing, e.g., InfiniBand, Fibre Channel, etc., may be utilized.

Network nodes consistent with the present disclosure are configured to implement MAC discovery using globally unique MAC addresses in order to identify other computing devices reachable by a respective network node (i.e., computing device). The information provided by the discovery process may then be utilized for forwarding control traffic from/to the centralized controller in-band. This is unlike conventional SDN where control traffic is carried out-of-band. A centralized controller consistent with the present disclosure may be configured to assign and/or manage assignment (e.g., by a DHCP (Dynamic Host Configuration Protocol) server) of IP (Internet Protocol) addresses to each network node where each network node may include one or more ports. This is unlike conventional distributed networking where each port may be assigned an IP address. The centralized controller may be further configured to program forwarding rules utilized by the computing devices in-band using IP address (i.e., non-control) frames.

Thus, a method and system consistent with the present disclosure is configured to implement distributed networking with local intelligence enhanced by centralized programmability. Network nodes, consistent with the present disclosure, may thus respond relatively more quickly to network changes, e.g., link loss and/or congestion while providing programmability. Centralized controller messages to/from network nodes may be carried in-band thereby eliminating a need for out-of-band communication capability associated with conventional SDN controllers.

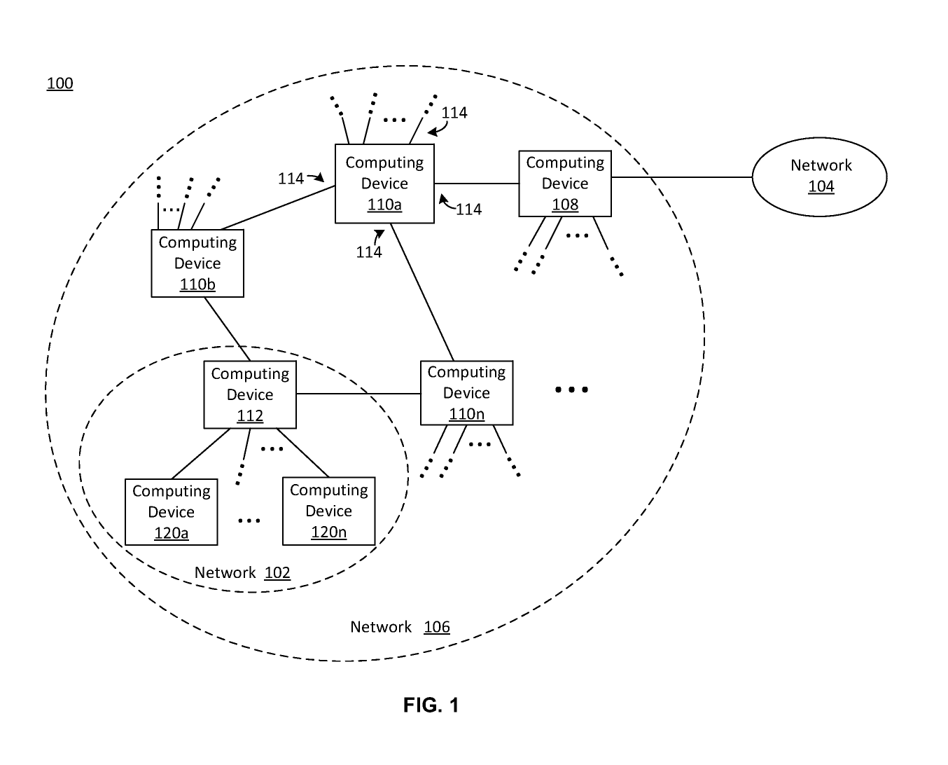

FIG. 1 illustrates a functional block diagram of an example network system 100 according to one embodiment of the present disclosure. The network system 100 includes a plurality of networks 102, 104, 106 and a plurality of computing devices 108, 110a, . . . , 110n, 112, 120a, . . . , 120n. One or more of networks 102, 104 and 106 may correspond to switch fabrics and the computing devices 108, 110a, . . . , 110n, 112, 120a, . . . , 120n may be configured to communicate using a switch fabric protocol such as Ethernet, InfiniBand and/or Fibre Channel, as described herein. Computing devices, as used herein, may include network devices (e.g. switches, routers, gateways, etc.) and/or compute devices (e.g., servers, desktop computers, portable computing devices, laptop computers, tablet computers, smartphones, etc.). Generally, a network node corresponds to a computing device and an endpoint may correspond to a compute device. Each computing device 108, 110a, . . . , 110n, 112, 120a, . . . , 120n generally includes a processor and input/output (I/O) circuitry (e.g., a network interface) and may include memory, as described herein. Each computing device 108, 110a, . . . , 110n, 112, 120a, . . . , 120n may include one or more network ports (e.g., network ports 114 of computing device 110a) configured to couple the respective computing device 108, 110a, . . . , 110n, 112, 120a, . . . , 120n to one or more other computing device(s) 108, 110a, . . . , 110n, 112, 120a, . . . , 120n.

Continuing with this example, computing device 108 may correspond to a gateway configured to couple network 104 and network 106 and configured to forward network traffic between network 104 and network 106, as described herein. Computing devices 110a, . . . , 110n may correspond to, e.g., routers and/or switches configured to couple other computing devices and to forward network traffic between those other computing devices. Computing device 112 may correspond to a router and/or a switch configured to couple computing devices 120a, . . . , 120n to each other and to other computing devices, e.g., computing devices 108, 110a, . . . , 110n, in network 106. Computing devices 108, 110a, . . . , 110n, 112 may thus correspond to network devices and computing devices 120a, . . . , 120n may correspond to compute nodes in this example. Compute nodes are generally not configured as network devices, i.e., their primary functions are not related to switching, routing and/or forwarding network traffic. Compute nodes may thus include fewer network ports than network devices. Computer nodes may further correspond to “edges” of a network.

Of course, network system 100 is merely one example network system. Other network systems may include more or fewer networks and/or more or fewer computing devices that may be configured differently.

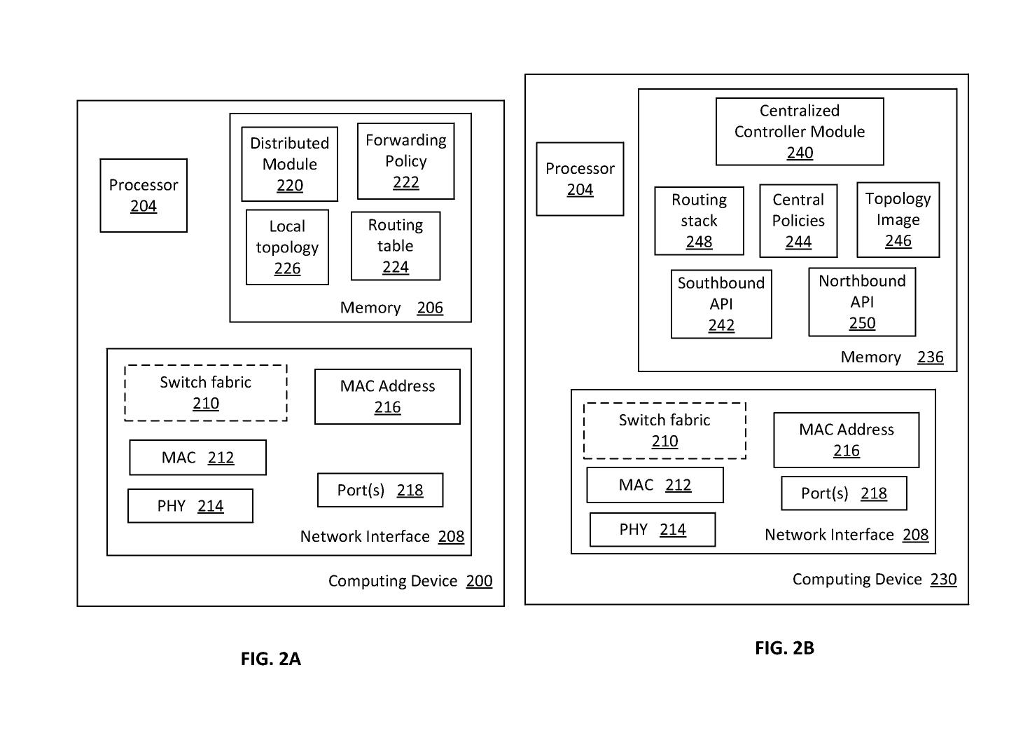

FIG. 2A illustrates a functional block diagram of one example computing device 200, consistent with one embodiment of the present disclosure. The example computing device 200 is one example of computing devices 108, 110a, . . . , 110n, 112, 120a, . . . , 120n of FIG. 1. Computing device 200 includes a processor 204, memory 206 and a network interface 208. Processor 204 may include one or more processing unit(s) and is configured to perform operations associated with computing device 200, as described herein. Network interface 208 is configured to couple computing device 200 to one or more networks, e.g., networks 102, 104 and/or 106 of FIG. 1, and thereby to other computing device(s). Network interface 208 is configured to communicate over network 106 using one or more communication protocols including, but not limited to, Ethernet, InfiniBand and/or Fibre Channel, as described herein.

Network interface 208 may include a media access controller (MAC) 212, physical layer circuitry PHY 214, a MAC address 216 and one or more port(s) 218. MAC 212 and PHY 214 are configured to couple computing device 200 to, e.g., network 106. MAC address 216 is a globally unique identifier configured to identify its associated network interface 208. MAC 212 is configured to perform media access management for transmit and receive functions. PHY circuitry 214 includes transmit circuitry configured to transmit data and/or message packets and/or frames to the network 106. PHY circuitry 214 includes receive circuitry configured to receive data and or message packets and/or frames from the network 106. Of course, PHY circuitry 214 may also include encoding/decoding circuitry configured to perform analog-to-digital and digital-to-analog conversion, encoding and decoding of data, analog parasitic cancellation (for example, cross talk cancellation), and recovery of received data. In some embodiments, e.g., for computing devices that correspond to network devices, network interface 208 may include a plurality of ports 218 and may include a switch fabric 210 configured to couple the plurality of ports 218.

Memory 206 is configured to store distributed module 220 and forwarding policy 222 and may be configured to store routing table 224 and/or a local topology 226. Distributed module 220 is configured to manage network interface operations (e.g., identifying other computing nodes and/or forwarding control traffic and/or data traffic) of computing device 200 and to communicate with a centralized controller (e.g., to receive the forwarding policies 222 and/or to provide local topology 226 information).

Distributed module 220 is configured to identify each other computing device, e.g., one or more of computing devices 108, 110a, . . . , 110n, 112, 120a, . . . , 120n, that may be directly connected to computing device 200. Identifying may include MAC discovery, establishing connection(s) and advertising. Distributed module 220 is configured to implement MAC discovery. For example, distributed module 220 may be configured to implement MAC discovery in response to power up of computing device 200, in response to computing device 200 being coupled to network 102, 104 and/or 106 of FIG. 1 and/or in response to another computing device coupling to computing device 200. MAC discovery is configured to allow computing device 200 to detect other computing device(s) that are directly connected to computing device 200. “Directly connected” as used herein means that there is not another computing device between two directly connected computing devices. Two computing devices that are directly connected to each other may be termed “link-local” relative to each other.

Each computing device, i.e., computing device 200, and other computing device(s) in the network may be configured with a globally unique identifier, e.g., MAC address 216. Distributed module 220 is configured to detect link-local computing device(s) and to establish connection(s) with the discovered link-local computing device(s). Distributed module 220 is then configured to advertise its link state information to its discovered link-local computing device(s). Link state information includes identifiers (e.g., MAC addresses) of link-local other computing device(s) directly connected to computing device 200.

Distributed module 220 may utilize the discovery and advertising process to determine which port of network interface 208 may be utilized to forward packet(s) to an identified computing device. Distributed module 220 may then store MAC addresses, port identifiers and distances to the discovered link-local computing devices in local topology 226. The advertised information may then be used by distributed module 220 and/or other computing devices to determine how to forward control traffic to any other computing device (via MAC address) that may be reachable in the network, e.g., network 106. For example, the determination may include a shortest path determination, e.g., a Dijkstra's algorithm. Traffic forwarding via MAC address may thus provide a default forwarding decision rule for distributed module 220. The default forwarding decision rule may then be utilized for forwarding control traffic and/or for forwarding data traffic if, e.g., a match on IP address does not yield a decision rule, as described herein.

Control traffic between, e.g., computing device 200 and a centralized controller module may be forwarded in-band utilizing MAC addresses and respective local topology. In other words, using the intelligence included in the computing devices, e.g., distributed module 220, and without (at least initially) forwarding policies defined by the centralized controller, the computing devices are configured to forward control traffic based, at least in part, on MAC address and local topology. Control traffic forwarding from/to the centralized controller may generally use a single path while general traffic (e.g., data traffic) may use one or more paths using a path selection function that preserves flow affinity (e.g. packet header hashing) Thus, control frame packets are able to traverse the network in-band, and data frames can maximize the use of available bandwidth by taking multiple paths.

Thus, the discovery process may be utilized by distributed module 220 to detect and identify link-local computing device(s). The distributed module 220 may then utilize the resulting network topology 226 to make forwarding decisions for, e.g., control traffic from a centralized controller, as described herein. The discovery process may be further utilized by distributed module 220 to detect addition of or loss of connection to another computing device. Thus, computing device 200 may locally detect changes in network topology that may affect forwarding decisions.

FIG. 2B illustrates a functional block diagram of another example computing device 230 consistent with various embodiments of the present disclosure. The example computing device 230 is one example of a computing device 108, 110a, . . . , 110n, 112, 120a, . . . , 120n of FIG. 1. Computing device 230 is configured to host a centralized controller module consistent with the present disclosure. Computing device 230 may be further configured to host a distributed module, forwarding policy, routing table and/or local topology (not shown) similar to the contents of memory 206 of computing device 200. Similar to computing device 200, computing device 230 includes a processor 204 and a network interface 208. Computing device 230 further includes a memory 236. Memory 236 is configured to store centralized controller module 240, Southbound API (application programming interface) 242, central policies 244 and Northbound API 250. Memory 236 may be further configured to store a topology image 246 and a routing stack 248.

Centralized controller module 240 is configured to retrieve discovery information from, and to provide forwarding policies (e.g., forwarding policies 222) to, computing devices, e.g., computing device 200, configured to be controlled and/or managed by centralized controller module 240. The forwarding policies 222 may be determined by, e.g., the centralized controller module 240 and may be based, at least in part, on one or more of central policies 244. Computing device 230 may be configured to receive central policies 244 information from, e.g., a network administrator, that is configured to implement a user-defined central policy. A network administrator may define and store one or more central polic(ies) 244 utilizing Northbound API 250 (and a user-interface application (not shown)). Centralized controller module 240 may then utilize the central policies 244 for setting forwarding policies 222 for the computing devices. Central policies 244 may include indicators related to physical changes to a network, e.g., network 106 (e.g., addition and/or removal of computing device(s) and/or policies related to forwarding functions). Forwarding functions may range from relatively basic, e.g., forward all traffic on one of N connections, to relatively complex, e.g., forward traffic through a topology, as described herein. Central policies 244 may include, for example, whether to enable load-balancing, whether to enable parallel paths, e.g., for fault tolerance and/or bandwidth considerations, etc. Central policies 244 may further include enabling appliance forwarding configured to facilitate analyzing packet contents. Thus, a relatively wide range of forwarding behaviors may be defined and stored as central policies 244. Centralized controller module 240 may then determine forwarding policies based, at least in part on, central polic(ies) 244. Thus, forwarding polic(ies) 222 may be defined by a network administrator using Northbound API 250 and central policies 244. A relatively broad range of forwarding functions may be defined and/or modified by the network administrator, as appropriate.

Centralized controller module 240 is configured to determine a topology image 246 based, at least in part, on discovery information received from computing devices, e.g., computing device 200. Centralized controller module 240 is configured to retrieve respective network topologies from the computing devices, e.g., local topology 226 of computing device 200. The network topology information may be related to routing stack 248 and may be stored as topology image 246. Thus, centralized controller module 240 may acquire a topology image without performing a discovery process for the network. Changes to network topology may be exposed to the centralized controller module 240 by the routing stack 248. Centralized controller module 240 may communicate with the computing devices using Southbound API 242. In an embodiment, Southbound API 242 may include functions that may comply or be compatible with the OpenFlow™ Switch Specification Version 1.1.0 Implemented (Wire Protocol 0x02) dated Feb. 28, 2011, and/or later versions of this specification. In another embodiment, Southbound API 242 may include custom and/or proprietary functions. The functions may be related to central policies 244. For example, the functions may be configured to describe forwarding and/or control mechanisms configured to allow a computing device, e.g., computing device 200, to respond to changes in local and/or network conditions detectable by the computing device 200, e.g., link loss, congestion.

Centralized controller module 240 may then determine forwarding policies based, at least in part, on central policies 244 and based, at least in part, on the topology image 246. Centralized controller module 240 may then forward the forwarding policies to respective computing devices, in-band, using Southbound API 242 and a destination MAC address. Computing devices may then utilize their respective local topology and/or respective routing table, e.g., routing table 224, to forward the forwarding policies to the target computing device(s) using MAC addresses.

The forwarding policies are configured to provide forwarding rules to the computing device 200. The forwarding policies may be flexible, i.e., may be configured to allow the computing device 200 to make a forwarding decision based, at least in part, on local and/or network conditions at the time the forwarding decision is made. For example, the forwarding may be based, at least in part, on one or more of packet header contents, discovery information, congestion information and/or configuration information provided by the centralized controller module 240. For example, header-based forwarding rules may be configured to implement forwarding based, at least in part, on layer 4, e.g., TCP (transport control protocol), network virtualization tunnel and/or a service header. The forwarding itself may change over time, e.g., as local and/or network conditions change. For example, the conditions may include, but are not limited to, congestion, discovery changes (e.g., computing devices joining or leaving a network, link loss, etc.), load balancing, etc. Thus, the computing device 200 may be configured to make forwarding decisions based, at least in part, on local and/or network conditions. The forwarding policies are configured to be multipath for non-control traffic forwarding. Thus, throughput may be increased and available bandwidth may be fully utilized.

Some forwarding policies may be configured to correspond with conventional distributed protocols (e.g., OSPF or BGP) by specifying an appropriate set of policies on each of the computing devices, e.g., computing device 200. Open Shortest Path First (OSPF) is a link-state routing protocol for IP networks that uses a link state routing algorithm. OSPF is an interior routing protocol configured to operate within a single autonomous system (AS), e.g., network. Border Gateway Protocol (BGP) is a standardized exterior gateway protocol designed to exchange routing and reachability information between autonomous systems, e.g., networks. Generally, forwarding policies may be configured to extend beyond conventional IP routing with relatively more fine-grained control over packet forwarding provided by, e.g., centralized controller module 240.

The centralized controller module 240 may be configured to assign IP (Internet protocol) addresses to one or more computing devices, e.g., computing device 200. Each computing device coupled to computing device 230 may be assigned an IP address. The IP addresses may be utilized for non-control traffic forwarding. Non-control traffic forwarding may be performed using endpoint to endpoint IP addresses. The IP addresses may be assigned using, for example, mapped from the MAC address. In some embodiments, the IP addresses may be assigned based, at least in part, on the network topology 246 in order to simplify forwarding. For example, computing devices 120a, . . . , 120n of FIG. 1 may correspond to compute devices that couple to network 106 via computing device (i.e., network device) 106. Thus, centralized controller module 240 may be configured to assign IP addresses to computing devices 120a, . . . , 120n so to facilitate utilizing an appropriate mask in a routing table so that packets destined for computing devices 120a, . . . , 120n are forwarded to computing device 112 from network 106.

Generally, centralized controller module 240 may be configured to assign an IP address to a computing device and not to each port of the computing device network interface 208. In some embodiments, port(s), e.g., port(s) 218 of computing device(s) consistent with the present disclosure that are coupled to conventional network devices may be assigned respective IP address(es). For example, a port that is configured to peer with a conventional network device may be assigned an IP address. Assigning IP addresses in this manner is configured to provide interoperability with conventional network devices.

Thus, centralized controller module 240 may be configured to provide forwarding policies to a plurality of computing devices. The forwarding policies may be based, at least in part, on network topology and based, at least in part, on central policies 244. The centralized controller module 240 may be configured to determine network topology based on local discovery information from the computing devices. The computing devices, e.g., computing device 200, may then be configured to implement distributed networking, i.e., to make forwarding decisions based on their respective forwarding policies without input from centralized controller module 240.

Forwarding policies may generally include a match on condition configured to compare packet information to a database, e.g., a routing table, an action if the match on condition is satisfied and a choice (i.e., decision rule). The database may be configured to relate an IP address to a MAC address of a destination computing device. The action generally includes forwarding by discovery to a destination MAC address. Discovery may include determining a path to the destination MAC address. In an embodiment, a relatively simple forwarding policy implemented, e.g., when a computing device joins a network and is provided an IP address may include matching on IP address X, forwarding by discovery to MAC Y and choosing a route by hash. This forwarding policy configures the computing device to utilize a discovery mechanism to choose the NextHop(s) that are configured to forward a packet towards MAC Y. If multiple paths of equal distance are found (as a result of the discovery) for the given MAC (i.e., MAC Y) a hash of the packet may be used to select the path.

In another embodiment, if IP addresses have been assigned according to connectivity (e.g., a network device coupled to a plurality of compute devices), the match on function may include masking IP addresses, and may thereby, simplify finding the appropriate forwarding information. The forwarding policy may include matching on IP address X utilizing Mask M, forwarding by discovery to MAC X or MAC Y and choosing between MAC X and MAC Y by hash. In this embodiment, a plurality of destination MACs may be specified. For example, the two MACs may correspond to two respective leaf servers in a Clos network, as described herein.

In another embodiment, computing devices situated at/or near an edge of a network (e.g., computing devices that are generally configured to perform compute tasks and that may be hosting VMs (virtual machines)) may typically have a relatively small number of ports. Such computing devices may be provided relatively simple forwarding policies. For example, these policies may be similar to forwarding rules configured to manage uplinks on a physical switch. The forwarding policy may include matching on all network IP addresses, forwarding by discovery to MAC W, MAC X, MAC Y, MAC Z and choosing by load. This example illustrates load balancing a compute node across four network connections. If at any time a MAC becomes unreachable (e.g., due to link loss, other computing device loss) the computing device is configured to locally make the decision to change the forwarding, e.g., to avoid packet loss. For example, the computing device may load balance across the remaining network connections.

In the foregoing description, reference is made to MAC addresses and IP addresses associated with the Ethernet protocol(s). MAC addresses correspond to globally unique identifiers and IP addresses correspond to assignable identifiers that may be used for, e.g., routing. The description may similarly apply to, e.g., Infiniband and/or Fibre Channel protocols that may provide and/or utilize unique identifiers for, e.g., packet forwarding.

In an embodiment, computing device 200 may be configured as a gateway, e.g., to couple two networks. Computing device 108 of FIG. 1 is an example of a computing device configured as a gateway (i.e., to couple network 106 and network 104). In this embodiment, non-control traffic from other computing device(s) may be addressed using an IP address assigned to computing device 200 by, e.g., centralized controller module 240. Computing device 200 may then be configured to move traffic between the two networks 104, 106. For example, network interface 208 may be configured with a number of ports configured to couple computing device 200 to one or more other computing devices and another set of ports connected to a router. Distributed module 200 may be configured to export routes to the connected router and peer with the connected router using conventional protocols such as OSPF or BGP. Thus, a heterogeneous or partial deployment of programmable distributed networking may be implemented alongside a conventional IP router.

FIG. 3 is a flowchart 300 of distributed networking operations according to various embodiments of the present disclosure. In particular, the flowchart 300 illustrates distributed networking including programmable forwarding policies. Operations of this embodiment include performing discovery 302. For example, a computing device may be configured to perform discovery to identify link-local computing device(s). Connection(s) may be established at operation 304. For example, connection(s) may be established with identified link-local computing device(s) discovered at operation 302. Operation 306 includes advertising to link partner(s). Each computing device may be configured to advertise link states including, e.g., the respective MAC address of each link partner. Operations 302, 304 306 may be configured to identify each directly connected computing device based, at least in part, on respective MAC addresses. An IP address may be received and stored at operation 308. For example, the IP address may be received from an centralized controller module. A forwarding policy may be received and stored at operation 310. For example, the forwarding policy may be received by a computing device from the centralized controller module. Received packets may be forwarded according to the forwarding policy at operation 312.

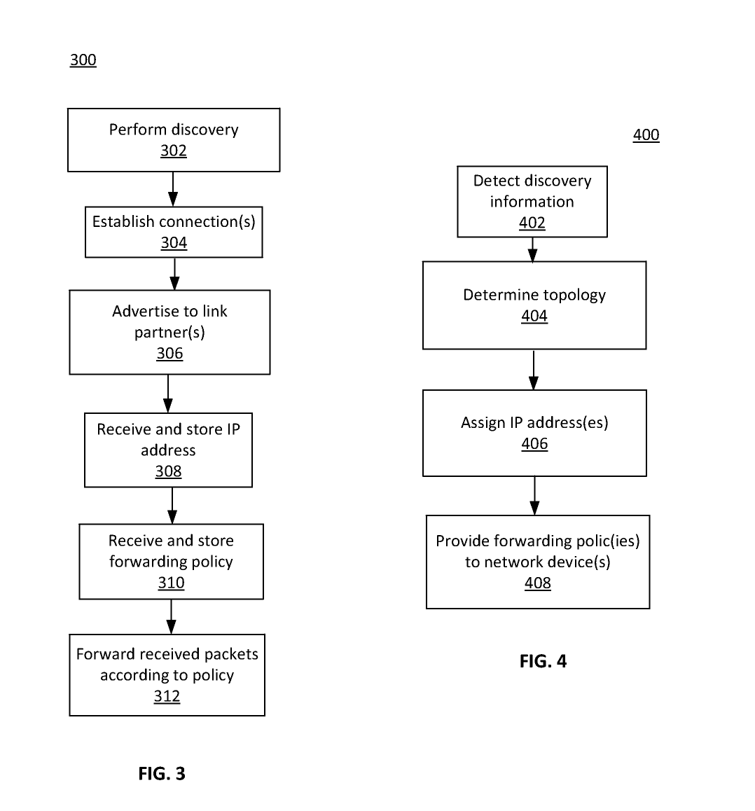

FIG. 4 is a flowchart 400 of programmable networking operations according to various embodiments of the present disclosure. In particular, the flowchart 400 illustrates operations configured to provide forwarding policies based, at least in part, on network topology, to computing devices. The operations of flowchart 400 may be performed by, e.g., centralized controller module 240. Operations of this embodiment begin with detecting discovery information 402. For example, discovery information may be detected by reading the routing stack of the computing device that includes the centralized controller. Topology may be determined at operation 404. IP address(es) may be assigned at operation 406. For example, the IP addresses may be assigned based, at least in part, on the topology determined at operation 404. The IP address assignment may be configured to exploit the topology to, e.g., simplify routing decisions. Forwarding polic(ies) may be provided to network device(s) at operation 408. The forwarding policies may be based, at least in part, on central policies set by, e.g., a network administrator.

Thus, flowcharts 300 and 400 illustrate programmable distributed networking, consistent with the present disclosure. Network devices are configured to perform discovery and link states. Centralized controller is configured to utilize discovery information to determine a network topology, assign IP addresses and to provide appropriate forwarding policies.

Thus, a computing device, e.g., computing device 200 and/or computing device 230, may be configured to implement programmable distributed networking by, e.g., a respective distributed module 220, as described herein. The computing device(s) 200, 230 are configured to identify other directly connected computing device(s) using a discovery process. Each computing device may be identified by, e.g., a MAC address. Each computing device may be further configured to determine a local topology and/or a network topology based, at least in part, on the discovery and/or related processes (e.g., advertising). Network topology information and MAC address(es) may then be utilized for communicating control traffic in band between, e.g., an centralized controller module and the computing device(s). The centralized controller module may then be configured to provide forwarding policies to the computing devices based at least in part on the network topology and based, at least in part, on central polic(ies) set by, e.g., a network administrator.

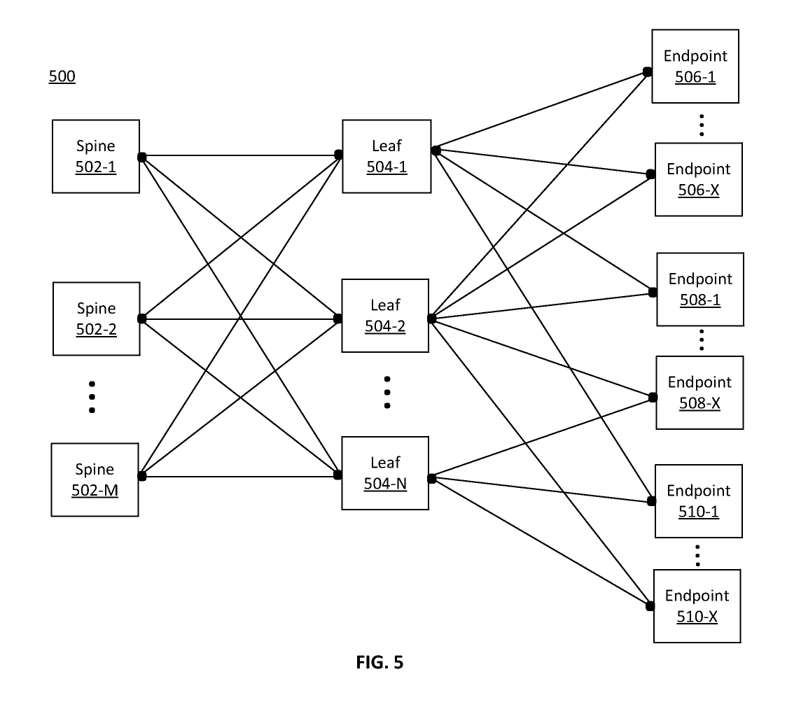

FIG. 5 is a functional block diagram of an example Clos network 500 according to one embodiment of the present disclosure. Clos network 500 includes N leaf computing devices 504-1, . . . , 504-N and M spine computing devices 502-1, . . . , 502-M. Clos network 500 further includes X endpoint computing devices for each leaf computing device 506-1, . . . , 506-X, 508-1, . . . , 508-X, 510-1, . . . , 510-X. Thus, Clos network 500 includes N*X endpoint computing devices 506-1, . . . , 506-X, 508-1, . . . , 508-X, 510-1, . . . , 510-X. Each of the N leaf computing devices 504-1, . . . , 504-N has at least one connection to each spine computing device 502-1, . . . , 502-M. Each endpoint computing device 506-1, . . . , 506-X, 508-1, . . . , 508-X, 510-1, . . . , 510-X is connected to two leaf computing devices. The endpoint computing devices 506-1, . . . , 506-X, 508-1, . . . , 508-X, 510-1, . . . , 510-X may typically be configured as compute devices.

Forwarding policies for endpoint computing devices 506-1, . . . , 506-X, 508-1, . . . , 508-X, 510-1, . . . , 510-X may be relatively simple. For example, the endpoint computing devices may be configured to match on all network IP addresses, forward by discovery to Leaf 1 MAC, Leaf 2 MAC and to choose between the two Leaf MACs by load. This configuration provides similar functionality as M-LAG (multi-switch link aggregation) or multi-chip LACP (link aggregation control protocol), and gives each endpoint server two redundant paths into the Clos. Link aggregation is configured to provide redundancy.

The leaf computing device 504-1, . . . , 504-N forwarding rules may also be relatively simple. For example, the leaf computing devices 504-1, . . . , 504-N may be configured to match on all directly connected IP addresses and to forward by discovery to directly connected MACs. In this example, traffic destined for endpoint computing devices 506-1, . . . , 506-X, 508-1, . . . , 508-X, 510-1, . . . , 510-X may be forwarded directly to the endpoint computing device 506-1, . . . , 506-X, 508-1, . . . , 508-X, 510-1, . . . , 510-X. The leaf computing devices 504-1, . . . , 504-N may be further configured to match on all network IP addresses, forward by discovery to Spine 1 MAC, Spine 2 MAC, Spine 3 MAC, Spine 4 MAC and to choose between spines by hash. Thus, traffic not destined to the endpoint servers may be directed to the spines (e.g., traffic coming from the endpoint computing devices would be forwarded in this manner).

The spine 502-1, . . . , 502-M forwarding rules may depend on whether IP addresses have been assigned based, at least in part, on an IP hierarchy configured to exploit network topology to reduce complexity associated with the match operation, as described herein. For example, if the IP addresses have been assigned without considering the IP hierarchy, then specific forwarding rules for the spine computing devices 502-1, . . . , 502-M for each leaf 504-1, . . . , 504-N and endpoint 506-1, . . . , 506-X, 508-1, . . . , 508-X, 510-1, . . . , 510-X computing device may be provided. The forwarding rules may include, for each IP Address A in the set of IP addresses for the leaf and endpoint computing devices, match on IP Address A, forward by discovery to the MAC corresponding to IP Address A and choose by hash. In this example, the centralized controller module, e.g., centralized controller module 230, has aliased the IP address to the MAC address. In another example, if the IP addresses have been assigned in a manner that incorporates the hierarchy (e.g., IP 192.168.x.* corresponds to all of endpoint computing devices connected through the same pair of leaf computing devices), the forwarding policy may then be match on IP Address 192.168.x.*, forward by discovery to Leaf 1 MAC, Leaf 2 MAC and choose by hash. Thus, in this example, the forwarding policy is configured to forward packets to the two leaf MACs associated with the plurality of endpoint computing devices connected to the two leaf computing devices.

While the flowcharts of FIGS. 3 and 4 illustrate operations according various embodiments, it is to be understood that not all of the operations depicted in FIGS. 3 and/or 4 are necessary for other embodiments. In addition, it is fully contemplated herein that in other embodiments of the present disclosure, the operations depicted in FIGS. 3 and/or 4, and/or other operations described herein may be combined in a manner not specifically shown in any of the drawings, and such embodiments may include less or more operations than are illustrated in FIGS. 3 and/or 4. Thus, claims directed to features and/or operations that are not exactly shown in one drawing are deemed within the scope and content of the present disclosure.

The foregoing provides example system architectures and methodologies, however, modifications to the present disclosure are possible. For example, computing device 200 and/or computing device 230 may also include chipset circuitry. Chipset circuitry may generally include “North Bridge” circuitry (not shown) to control communication between a processor, I/O circuitry and memory.

Computing device 200 and/or computing device 230 may each further include an operating system (OS) to manage system resources and control tasks that are run on each respective device and/or system. For example, the OS may be implemented using Microsoft Windows, HP-UX, Linux, or UNIX, although other operating systems may be used. In some embodiments, the OS may be replaced by a virtual machine monitor (or hypervisor) which may provide a layer of abstraction for underlying hardware to various operating systems (virtual machines) running on one or more processing units.

The operating system and/or virtual machine may implement one or more protocol stacks. A protocol stack may execute one or more programs to process packets. An example of a protocol stack is a TCP/IP (Transport Control Protocol/Internet Protocol) protocol stack comprising one or more programs for handling (e.g., processing or generating) packets to transmit and/or receive over a network. A protocol stack may alternatively be comprised on a dedicated sub-system such as, for example, a TCP offload engine and/or I/O circuitry. The TCP offload engine circuitry may be configured to provide, for example, packet transport, packet segmentation, packet reassembly, error checking, transmission acknowledgements, transmission retries, etc., without the need for host CPU and/or software involvement.

Computing device 200 and/or computing device 230 may communicate with each other, via network 100 using a switched fabric communications protocol, for example, an Ethernet communications protocol, InfiniBand communications protocol, Fibre Channel communications protocol, etc. The Ethernet communications protocol may be capable of providing communication using a Transmission Control Protocol/Internet Protocol (TCP/IP). The Ethernet protocol may comply or be compatible with the Ethernet standard published by the Institute of Electrical and Electronics Engineers (IEEE) titled “IEEE 802.3 Standard”, published in March, 2002 and/or later versions of this standard, for example, the IEEE 802.3 Standard for Ethernet, published 2012. The InfiniBand protocol may comply or be compatible with the InfiniBand specification published by the InfiniBand Trade Association (IBTA), titled “InfiniBand™ Architecture Specification”, Volume 1, Release 1.2.1, published June 2001 and/or later versions of this specification, for example, InfiniBand™ Architecture, Volume 1 (General Specification), Release 1.2.1, published January 2008 and Volume 2 (Physical Specification), Release 1.3, published November 2012. The Fibre Channel protocol may comply or be compatible with the Fibre Channel specification published by the American National Standards Institute (ANSI), for example, Fibre Channel over Ethernet by INCITS (ANSI) titled BB-5 Rev 2.0 June 2009. Of course, in other embodiments, the switched fabric communications protocol may include a custom and/or proprietary switched fabric communications protocol.

Memory 206 and/or memory 236 may comprise one or more of the following types of memory: semiconductor firmware memory, programmable memory, non-volatile memory, read only memory, electrically programmable memory, random access memory, flash memory, magnetic disk memory, and/or optical disk memory. Either additionally or alternatively system memory may comprise other and/or later-developed types of computer-readable memory.

Embodiments of the operations described herein may be implemented in a system that includes one or more storage devices having stored thereon, individually or in combination, instructions that when executed by one or more processors perform the methods. The processor may include, for example, a processing unit and/or programmable circuitry. The storage device may include any type of tangible, non-transitory storage device, for example, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of storage devices suitable for storing electronic instructions.

“Circuitry”, as used in any embodiment herein, may comprise, for example, singly or in any combination, hardwired circuitry, programmable circuitry, state machine circuitry, and/or firmware that stores instructions executed by programmable circuitry. “Module”, as used herein, may comprise, singly or in any combination circuitry and/or code and/or instructions sets (e.g., software, firmware, etc.).

In some embodiments, a hardware description language may be used to specify circuit and/or logic implementation(s) for the various modules and/or circuitry described herein. For example, in one embodiment the hardware description language may comply or be compatible with a very high speed integrated circuits (VHSIC) hardware description language (VHDL) that may enable semiconductor fabrication of one or more circuits and/or modules described herein. The VHDL may comply or be compatible with IEEE Standard 1076-1987, IEEE Standard 1076.2, IEEE1076.1, IEEE Draft 3.0 of VHDL-2006, IEEE Draft 4.0 of VHDL-2008 and/or other versions of the IEEE VHDL standards and/or other hardware description standards.

Thus, consistent with the teachings of the present disclosure, a system and method are configured to provide programmable distributed networking. A plurality of network nodes (i.e., computing devices) are configured to perform a discovery process to identify link partners and a network topology based, at least in part, on globally unique identifiers (e.g., MAC addresses). Control traffic from a centralized controller (that may be included in one of the computing devices) may then be forwarded in-band by the computing devices based, at least in part, on the MAC addresses and based, at least in part, on the network topology. The centralized controller is configured to provide forwarding rules and/or policies to the computing devices. The forwarding policies may be based on, e.g., network topology and central polic(ies) provided by, e.g., a network administrator. The forwarding policies may range from relatively simple to relatively complex and may include decision rules that depend on existing conditions (e.g., congestion) at the computing device when the forwarding decision is made. Thus, resilience associated with distributed networking may be preserved while also providing centralized programmability. Workloads associated with network functionality may then be shared between distributed computing devices and the centralized controller.

Accordingly, the present disclosure provides an example computing device. The example computing device includes a processor; a network interface comprising at least one port and a network interface identifier; and a distributed module. The distributed module is configured to identify each directly connected other computing device, receive and store a forwarding policy from a centralized controller module, and forward a received packet based, at least in part, on the forwarding policy.

The present disclosure also provides a network system. The example network system includes a plurality of computing devices. Each computing device includes a processor; a network interface comprising at least one port and a network interface identifier; and a distributed module. The distributed module is configured to identify each directly connected other computing device, receive and store a forwarding policy from a centralized controller module, and forward a received packet based, at least in part, on the forwarding policy.

The present disclosure also provides an example method. The example method includes identifying, by a distributed module, each directly connected computing device based, at least in part, on a respective network interface identifier; receiving and storing, by the distributed module, a forwarding policy from a centralized controller module; and forwarding, by the distributed module, a received packet based, at least in part, on the forwarding policy.

The present disclosure also provides an example system that includes one or more storage devices having stored thereon, individually or in combination, instructions that when executed by one or more processors result in the following operations including: identifying each directly connected computing device based, at least in part, on a respective network interface identifier; receiving and storing a forwarding policy from a centralized controller module; and forwarding a received packet based, at least in part, on the forwarding policy.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

What is claimed is:

1. A computing device, comprising:
a processor;
a network interface comprising at least one port and a network interface identifier; and
a distributed module configured to identify each directly connected other computing device, receive and store a forwarding policy from a centralized controller module, and forward a received packet based, at least in part, on the forwarding policy.

2. The computing device of claim 1, further comprising the centralized controller module.

3. The computing device of claim 1, wherein the forwarding policy is received by the network interface in-band.

4. The computing device of claim 1, wherein the network interface identifier is a MAC (media access control) address, the distributed module is further configured to receive an IP (Internet Protocol) address from the centralized controller module and the received packet is forwarded based, at least in part, on the IP address.

5. The computing device of claim 1, wherein the forwarding is based, at least in part, on network conditions local to the computing device.

6. A network system, comprising:
a plurality of computing devices, each computing device comprising:
a processor;
a network interface comprising at least one port and a network interface identifier; and
a distributed module configured to identify each directly connected other computing device, receive and store a forwarding policy from a centralized controller module, and forward a received packet based, at least in part, on the forwarding policy.

7. The network system of claim 6, wherein one of the computing devices further comprises the centralized controller module.

8. The network system of claim 6, wherein the forwarding policy is received by each network interface in-band.

9. The network system of claim 6, wherein the network interface identifier is a MAC (media access control) address, each distributed module is further configured to receive a respective IP (Internet Protocol) address from the centralized controller module and each received packet is forwarded based, at least in part, on the respective IP address.

10. The network system of claim 6, wherein the forwarding is based, at least in part, on network conditions local to the respective computing device.

11. A method, comprising:
identifying, by a distributed module, each directly connected computing device based, at least in part, on a respective network interface identifier;
receiving and storing, by the distributed module, a forwarding policy from a centralized controller module; and
forwarding, by the distributed module, a received packet based, at least in part, on the forwarding policy.

12. The method of claim 11, further comprising:
providing, by the centralized controller module, the forwarding policy in-band.

13. The method of claim 11, further comprising:
storing, by the distributed module, a local topology related to each respective network interface identifier; and
determining, by the centralized controller module, a network topology based, at least in part, on the local topology.

14. The method of claim 11, further comprising:
determining, by the distributed module, local network conditions, the forwarding based, at least in part, on the local network conditions.

15. The method of claim 13, further comprising:
assigning, by the centralized controller module, an IP (Internet Protocol) address to at least some of the directly connected computing devices based, at least in part, on the network topology.

16. A system comprising, one or more storage devices having stored thereon, individually or in combination, instructions that when executed by one or more processors result in the following operations comprising:
identifying each directly connected computing device based, at least in part, on a respective network interface identifier;
receiving and storing a forwarding policy from a centralized controller module; and
forwarding a received packet based, at least in part, on the forwarding policy.

17. The system of claim 16, wherein the instructions that when executed by one or more processors results in the following additional operations comprising:
providing the forwarding policy in-band.

18. The system of claim 16, wherein the instructions that when executed by one or more processors results in the following additional operations comprising:
storing a local topology related to each respective network interface identifier; and
determining a network topology based, at least in part, on the local topology.

19. The system of claim 16, wherein the instructions that when executed by one or more processors results in the following additional operations comprising:
determining local network conditions, the forwarding based, at least in part, on the local network conditions.

20. The system of claim 18, wherein the instructions that when executed by one or more processors results in the following additional operations comprising:
assigning an IP (Internet Protocol) address to at least some of the directly connected computing devices based, at least in part, on the network topology.
